(19) United States
(12) Patent Application Publication
(10) Pub. No.: US 2009/0087706 A1
(43) Pub. Date: Apr. 2, 2009

(54) Fuel cell power generation system

(75) Inventors: Jae-Hyoung Gil, Seoul (KR); Jae-Hyuk Jang, Seongnam-si (KR); Kyoung-Soo Chae, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/213,462

(22) Filed: Jun. 19, 2008

(30) Foreign Application Priority Data
Sep. 28, 2007 (KR) 10-2007-0098382

(51) Int. Cl. H01M 8/04

(52) U.S. Cl. 429/25

(57) ABSTRACT

A fuel cell power generation system that includes: a hydrogen generating apparatus which generates hydrogen; a fuel electrode, of which a portion is coupled to the hydrogen generating apparatus so as to receive the hydrogen and dissociate the hydrogen into hydrogen ions and electrons, and in which a fuel channel is formed that has one side open; a membrane, stacked over the fuel electrode such that the membrane covers the open side of the fuel channel; an air electrode, which is coupled to the membrane, and which receives the hydrogen ions from the fuel electrode through the membrane; and a pressure sensor, which is formed on the portion of the fuel electrode, and which measures a pressure inside the fuel channel and regulates a quantity of hydrogen supplied to the fuel electrode. With this system, the flow rate of hydrogen can be regulated in a simple manner.

### CROSS-REFERENCE TO RELATED APPLICATIONS

This application claims the benefit of Korean Patent Application No. 10-2007-0098382 filed with the Korean Intellectual Property Office on Sep. 28, 2007, the disclosure of which is incorporated herein by reference in its entirety.

### BACKGROUND

1. Technical Field

The present invention relates to a fuel cell power generation system.

2. Description of the Related Art

A fuel cell is an apparatus that converts the chemical energies of fuel (hydrogen, LNG, LPG, etc.) and air directly into electricity and heat, by means of electrochemical reactions. In contrast to conventional power generation techniques, which employ the processes of burning fuel, generating vapor, driving turbines, and driving power generators, the utilization of fuel cells does not entail combustion processes or driving apparatus. As such, the fuel cell is a relatively new technology for generating power, which offers high efficiency and few environmental problems.

FIG. 1 is a diagram illustrating the operational principle of a typical fuel cell.

Referring to FIG. 1, a fuel cell 100 may include a fuel electrode 110 as an anode and an air electrode 130 as a cathode. The fuel electrode 110 receives molecular hydrogen (H₂), which is dissociated into hydrogen ions (H⁺) and electrons (e⁻). The hydrogen ions move past a membrane 120 towards the air electrode 130. This membrane 120 corresponds to an electrolyte layer. The electrons move through an external circuit 140 to generate an electric current. The hydrogen ions and the electrons combine with the oxygen in the air at the air electrode 130 to generate water. The following Reaction Scheme 1 represents the chemical reactions described above.

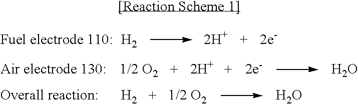

In short, the fuel cell can function as a battery, as the electrons dissociated from the fuel electrode 110 generate a current that passes through the external circuit. Such a fuel cell 100 is a pollution-free power source, because it does not produce any polluting emissions such as SOx, NOx, etc., and produces only little amounts of carbon dioxide. Also, the fuel cell may offer several other advantages, such as low noise and little vibration, etc.

One of the most crucial tasks required for the fuel cell is the stable supply of hydrogen. A hydrogen storage tank can be used for this purpose, but the tank apparatus occupies a large volume and has to be kept with special care.

In order for the fuel cell to suitably accommodate the demands in current portable electronic equipment (cell phones, laptops, etc.) for high-capacity power supply apparatus, the fuel cell needs to provide a small volume and high performance.

Thus, a reasonable alternative can be to produce hydrogen using a hydrogen generating apparatus. The hydrogen generating apparatus may convert a regular fuel containing hydrogen atoms into gases containing a large quantity of hydrogen gas, which can then be used by the fuel cell 100.

The fuel cell may employ a method of generating hydrogen after reforming fuel, such as methanol or formic acid, etc., approved by the ICAO (International Civil Aviation Organization) for boarding on airplanes, or may employ a method of using methanol, ethanol, or formic acid, etc., directly as the fuel.

However, the former case may require a high reforming temperature, a complicated system, and high driving power, and is likely to have impurities (e.g. CO₂, CO, etc.) included, besides pure hydrogen. On the other hand, the latter may entail the problem of very low power density, due to the low rate of a chemical reaction at the anode and the cross-over of hydrocarbons through the membrane.

In comparison, by using a hydrogen generating apparatus that utilizes electrochemical reactions, pure hydrogen can be obtained at room temperature. Also, a simple system can be implemented using only a cartridge and stack, and it is possible to obtain a desired flow rate of hydrogen without a separate BOP unit, by regulating the electric current to control the amount of hydrogen produced.

FIG. 2 is a block diagram illustrating a feedback system for regulating hydrogen flow rate according to the related art. The conventional method of regulating the flow rate of hydrogen may include reducing the resistance between electrodes and regulating the flow rate using a control unit comprising a switch or a variable resistance.

As illustrated in the drawing, for on-demand control, the control unit may receive feedback on the power required by the fuel cell or the electronic device (mobile phone) to which the fuel cell is connected, and may increase the hydrogen flow rate, if the value is greater than the current power of the fuel cell, or decrease the hydrogen flow rate, if the value is lower. This method of regulating hydrogen flow rate may entail certain difficulties, however, in that complicated circuit designs are needed and that the power requirements have to be measured exactly.

In other words, the flow rate of hydrogen may need to be regulated in accordance with the power consumption requirement of the fuel cell and electronic device, and as the voltage or current has to be measured through the circuits, the system can be made complicated.

### SUMMARY

An aspect of the invention is to provide a fuel cell power generation system, with which the flow rate of hydrogen supplied from the hydrogen generating apparatus to the fuel cell can be regulated in a simple manner, and with which the stability of the hydrogen generating apparatus can be improved.

One aspect of the invention provides a fuel cell power generation system that includes: a hydrogen generating apparatus which generates hydrogen; a fuel electrode, of which a portion is coupled to the hydrogen generating apparatus so as to receive the hydrogen and dissociate the hydrogen into hydrogen ions and electrons, and in which a fuel channel is formed that has one side open; a membrane, stacked over the fuel electrode such that the membrane covers the open side of the fuel channel; an air electrode, which is coupled to the membrane, and which receives the hydrogen ions from the fuel electrode through the membrane; and a pressure sensor, which is formed on the portion of the fuel electrode, and which measures a pressure inside the fuel channel and regulates a quantity of hydrogen supplied to the fuel electrode.

Here, the hydrogen generating apparatus can include: an electrolyte bath, which contains an electrolyte solution including hydrogen ions; a first electrode, which is positioned inside the electrolyte bath and dipped in the electrolyte solution, and which is configured to generate electrons; a second electrode, which is positioned inside the electrolyte bath and dipped in the electrolyte solution, and which is configured to receive the electrons and generate hydrogen; and a control unit, which is positioned between the first electrode and the second electrode and configured to control an amount of electrons flowing from the first electrode to the second electrode in correspondence to a pressure required at the fuel electrode.

The control unit may control the amount of electrons according to a pressure value inputted by a user.

Also, the fuel channel may be of a dead end structure, in which one end portion of the channel is isolated from the exterior.

The fuel cell power generation system may further include a valve, which may be interposed between the fuel electrode and the hydrogen generating apparatus, and which may regulate an internal pressure of the hydrogen generating apparatus.

In certain embodiments, an air channel may be formed in the air electrode that is in correspondence with the fuel channel.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a diagram illustrating the operational principle of a typical fuel cell.

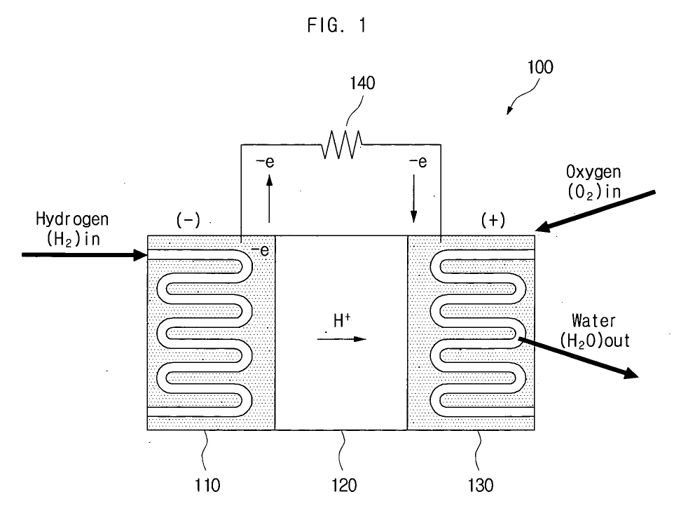

FIG. 2 is a block diagram illustrating a feedback system for regulating hydrogen flow rate according to the related art.

FIG. 3 is a schematic diagram illustrating a hydrogen generating apparatus.

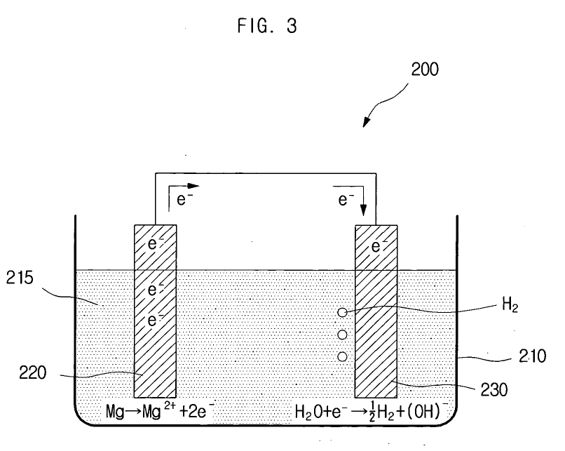

FIG. 4 is a cross-sectional view of a fuel cell power generation system according to an embodiment of the invention.

FIG. 5 is a perspective view of a fuel electrode according to an embodiment of the invention.

FIG. 6 is a flowchart illustrating a method of regulating hydrogen flow rate according to an embodiment of the invention.

### DETAILED DESCRIPTION

As the invention allows for various changes and numerous embodiments, particular embodiments will be illustrated in drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

While such terms as “first,” “second,” etc., may be used to describe various elements, such elements must not be limited to the above terms. The above terms are used only to distinguish one element from another.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Certain embodiments of the invention will now be described below in more detail with reference to the accompanying drawings.

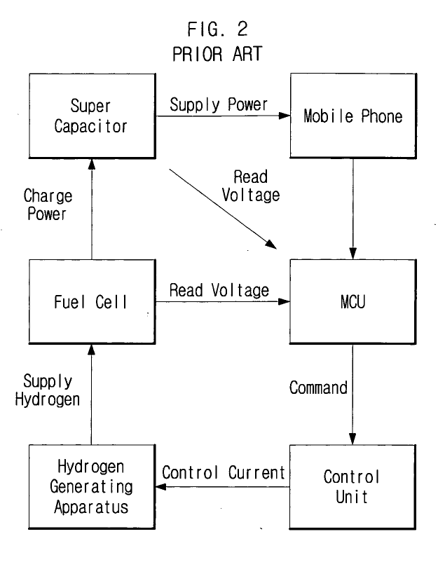

Methods used in generating hydrogen for a proton exchange membrane fuel cell (PEMFC) can be divided mainly into methods utilizing the oxidation of aluminum, methods utilizing the hydrolysis of metal borohydrides, and methods utilizing reactions on metal electrodes. Among these, one method of efficiently adjusting the rate of hydrogen generation is the method of using metal electrodes. FIG. 2 is a schematic diagram illustrating a hydrogen generating apparatus that uses metal electrodes.

In the illustrated drawing, an anode 220 made of magnesium and a cathode 230 made of stainless steel are dipped in an aqueous electrolyte solution 215 inside an electrolyte bath 210.

The basic principle of the hydrogen generating apparatus 200 is that electrons are generated at the magnesium electrode 220, which has a greater tendency to ionize than the stainless steel electrode 230, and the generated electrons travel to the stainless steel 230 electrode. The electrons can then react with the aqueous electrolyte solution 215 to generate hydrogen.

The following Reaction Scheme 2 represents the chemical reactions in the hydrogen generating apparatus 200 described above.

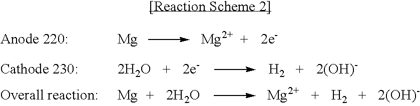

This is a method in which the electrons obtained when magnesium in the electrode 220 is ionized to Mg²⁺ ions are moved through a wire and connected to another metal object (e.g. aluminum or stainless steel), where hydrogen is generated by the dissociation of water. The amount of hydrogen generated can be adjusted on demand, as it is related to the flow or cut-off of electricity, the distance between electrodes, and the sizes of the electrodes.

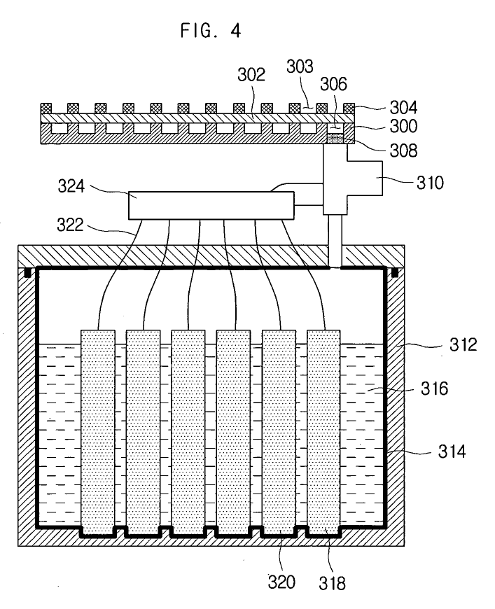

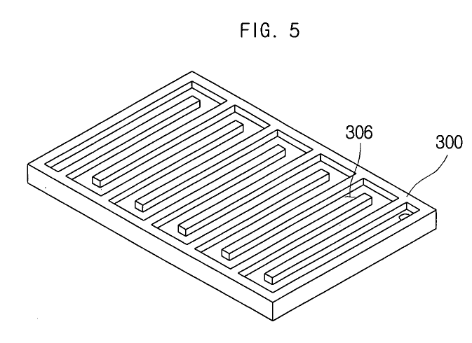

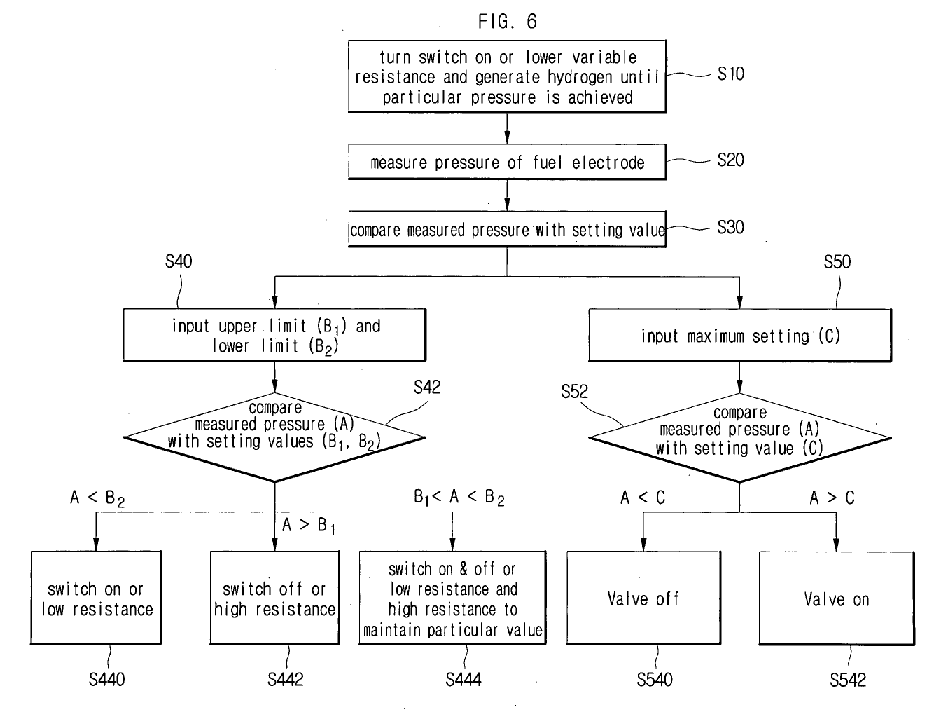

FIG. 4 is a cross-sectional view of a fuel cell power generation system according to an embodiment of the invention, FIG. 5 is a perspective view of a fuel electrode according to an embodiment of the invention, and FIG. 6 is a flowchart illustrating the regulating of hydrogen flow rate according to an embodiment of the invention. In FIG. 4 or FIG. 5 are illustrated a fuel electrode 300, a membrane 302, an air electrode 304, a fuel channel 306, an air channel 303, a pressure sensor 308, a valve 310, an electrolyte bath 312, an elastic member 314, an aqueous electrolyte solution 316, first electrodes 318, second electrodes 320, wires 322, and a control unit 324.

Utilizing certain embodiments of the invention, the flow rate of hydrogen can be regulated in a simple manner by regulating pressure, without having to use a complicated feedback system which measures the power value of an electronic device and measures the power value of the fuel cell.

For better understanding and easier explanations, the following description will focus on a configuration in which the first electrode 318 is made of magnesium (Mg) and the second electrode 320 is made of stainless steel.

The fuel electrode 300 may be a fuel electrode 300 of the fuel cell, and may receive the hydrogen generated in a hydrogen generating apparatus and dissociate the hydrogen into hydrogen ions and electrons. One portion of the fuel electrode 300 may be connected to the hydrogen generating apparatus, and one side may form an open fuel channel 306.

The fuel electrode 300, as illustrated in FIG. 5, may employ a dead end structure, in which the end portion of the fuel channel 306 is blocked and isolated from the exterior. Because of this structure, the hydrogen supplied from the hydrogen generating apparatus can be held in the fuel channel 306 of the fuel electrode 300, and the pressure of the hydrogen held in the dead end structure can be measured.

A membrane 302 may be stacked on the fuel electrode 300 such that covers the open side of the fuel channel 306, and may allow the hydrogen ions created in the fuel electrode 300 to pass through.

The air electrode 304 may be coupled to the membrane 302, and may be provided with the hydrogen ions from the fuel electrode 300 through the membrane 302. The hydrogen ions can then combine with the electrons and the oxygen in the air to form water, while the electrons pass through an external circuit to generate an electric current.

An air channel 303 may be formed in the air electrode 304 that corresponds with the fuel channel 306, in order to hold the water produced.

The pressure sensor 308 may be formed at one portion of the fuel electrode 300, and may measure the pressure inside the fuel channel 306 to regulate the amount of hydrogen supplied to the fuel electrode 300 by measuring. As the hydrogen is expended while the fuel cell produces electrical power, the concentration of hydrogen will be decreased, for which more hydrogen may be supplied to achieve a desired concentration of hydrogen.

In order to achieve and maintain the desired concentration of hydrogen, the pressure sensor 308 may measure the pressure inside the fuel channel 306, which can be used to maintain a pressure according to a particular amount of hydrogen inside the fuel channel 306.

As such, by maintaining a pressure corresponding to a particular amount of hydrogen in the fuel electrode 300, the concentration of hydrogen can be maintained constant, whereby on-demand control is possible regardless of the power consumption in the electronic device.

If a problem occurs in regulating the flow rate of hydrogen in the fuel electrode 300, or a problem occurs regarding the internal pressure of the hydrogen generating apparatus, the valve 310 may be opened and the hydrogen may be purged. As such, the valve 310 may serve to keep the hydrogen generating apparatus safe. That is, if the pressure inside the hydrogen generating apparatus exceeds a certain level, the hydrogen may be exhausted.

The hydrogen generating apparatus may include an electrolyte bath 312, an elastic member 314, first electrodes 318, second electrodes 320, an aqueous electrolyte solution 316, wires 322, and a control unit 324.

The electrolyte bath 312 may have one side open, and may contain the elastic member 314 and the aqueous electrolyte solution 316 including hydrogen ions.

The elastic member 314 may be inserted inside the electrolyte bath 312 and may include in its inside the electrodes, including first electrodes 318 and second electrodes 320, and the aqueous electrolyte solution 316. The elastic member 314 can be made of rubber or vinyl, and when the aqueous electrolyte solution 316 is placed inside the elastic member 314, the elastic member 314 may change its shape to fit the form of the electrolyte bath 312.

The elastic member 314 formed inside the electrolyte bath 312 may elastically expand according to the amount of aqueous electrolyte solution 316. Also, when the cover is placed on the electrolyte bath 312, the elastic member 314 may be secured to an inner surface of the cover formed inside the electrolyte bath 312.

The electrodes 318, 320 can be grouped into first electrodes 318 and second electrodes 320, which may be connected to the wires 322 that serve as passages for the movement of electrons.

The aqueous electrolyte solution 316 may contain hydrogen ions, which can be used by the hydrogen generating apparatus to generate hydrogen gas. A compound such as LiCl, KCl, NaCl, KNO₃, NaNO₃, CaCl₂, MgCl₂, K₂SO₄, Na₂SO₄, MgSO₄, AgCl, etc., can be used in the aqueous electrolyte solution 316 as the electrolyte.

The first electrode 318 may be formed on one side within the electrolyte bath 312 and may generate electrons. The first electrode 318 may be an active electrode, where the magnesium (Mg) is oxidized into a magnesium ion (Mg²⁺) releasing two electrons, due to the difference in ionization energy between magnesium and water (H₂O).

The electrons thus generated may travel through the wire 322 to the control unit 324, and through the wire 322 to the second electrode 320. As such, the first electrode 318 may be expended in accordance with the electrons generated, and may have to be replaced after a certain period of time. Also, the first electrode 318 may be made of a metal having a greater tendency to ionize than the material used for the second electrode 320.

The second electrode 320 may be formed adjacent to the first electrode 318, and may generate hydrogen using the electrons and the aqueous electrolyte solution 316. The second electrode 320 may be an inactive electrode. The second electrode 320 may receive the electrons that have traveled from the magnesium of the first metal electrode 304 and may react with the aqueous electrolyte solution 316 to generate hydrogen.

Also, as the second electrode 320 may be an inactive electrode and may not be expended, unlike the first electrode 318, the second electrode 320 may be formed to a lower thickness than that of the first electrode 318.

To be more specific, the chemical reaction at the second electrode 320 involves water being dissociated at the second electrode 320 after receiving the electrons from the first electrode 318.

The reaction above can be represented by the following Reaction Scheme 3.

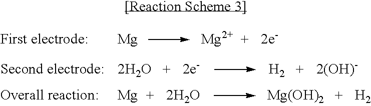

The rate and efficiency of the chemical reactions described above are determined by a number of factors. Examples of factors that determine the reaction rate include the area of the first electrode 318 and/or the second electrode 320, the concentration of the aqueous electrolyte solution 316, the type of aqueous electrolyte solution 316, the number of first electrodes 318 and/or second electrodes 320, the method of connection between the first electrode 318 and the second electrode 320, and the electrical resistance between the first electrode 318 and the second electrode 320.

Changes in the factors described above can alter the amount of electric current flowing between the first electrode 318 and second electrode 320, whereby the rate of the electrochemical reactions represented in Reaction Scheme 3 may be changed. A change in the rate of the electrochemical reactions will result in a change in the amount of hydrogen generated at the second electrode 320.

Thus, in embodiments of the invention, it is possible to regulate the amount of hydrogen generated by regulating the amount of electric current flowing between the first electrode 318 and the second electrode 320. The underlying principle of this can be explained by the following Equation 1 using Faraday's law.

$${N}_{hydrogen} = \frac{i}{nE} \\ {N}_{hydrogen} = \frac{i}{2 \times 96485} ( mol ) \\ \begin{matrix}{V}_{hydrogen} = \frac{i}{2 \times 96485} \times 60 \times 22400 ( ml \text{/} min ) \\ = 7 \times i ( ml \text{/} min )\end{matrix} \qquad [ Equation 1 ]$$

Here, N_{hydrogen} represents the amount of hydrogen generated per second (mol/sec), and V_{hydrogen} represents the volume of hydrogen generated per minute (ml/min). i represents current (C/s), n represents the number of reacting electrons, and E represents the charge per one mole of electrons (C/mol).

With reference to Reaction Scheme 3 described above, as two electrons react at the second electrode 320, n equals 2, and the charge per one mole of electrons is about −96,485 coulombs.

The volume of hydrogen generated in one minute can be calculated by multiplying the amount of hydrogen generated in one second by the time (60 seconds) and the volume of one mole of hydrogen (22,400 ml).

If the fuel cell is used in a 2 W system, the required amount of hydrogen may be about 42 ml/mol, and 6 A of electric current may be needed. If the fuel cell is used in a 5 W system, the required amount of hydrogen may be about 105 ml/mol, and 15 A of electric current may be needed.

Accordingly, by regulating the amount of electric current flowing between the first electrode 318 and the second electrode 320, the hydrogen generating apparatus can be made to generate the amount of hydrogen required by the connected fuel cell.

In embodiments of the invention, the first electrode 318 can be made of a metal other than magnesium that has a relatively high ionization tendency, such as iron (Fe) or an alkali metal such as aluminum (Al), zinc (Zn), etc. The second electrode 320 can be made of a metal such as platinum (Pt), copper (Cu), gold (Au), silver (Ag), iron (Fe), etc., that has a relatively lower ionization tendency than that of the metal used for the first electrode 318.

The control unit 324 may regulate the rate by which the electrons generated at the first electrode 318 by the electrochemical reactions are transferred to the second electrode 320, that is, the control unit 324 may regulate the electric current.

The control unit 324 may be inputted with the amount of power or amount of hydrogen required by the fuel cell, and if the required value is high, may increase the amount of electrons flowing from the first electrode 318 to the second electrode 320, or if the required value is low, may decrease the amount of electrons flowing from the first electrode 318 to the second electrode 320.

That is, the control unit 324 may control the amount of electrons flowing from the first electrode 318 to the second electrode 320 in correspondence to the pressure required in the fuel electrode 300. Also, the control unit 324 may control the amount of electrons in accordance with the pressure inputted by a user.

For example, the control unit 324 may include a variable resistance, to regulate the electric current flowing between the first electrode 318 and second electrode 320 by varying the resistance value, or may include an on/off switch, to regulate the electric current flowing between the first electrode 318 and second electrode 320 by controlling the on/off timing.

Also, the control unit 324 may be connected to the valve 310 and the wire 322 respectively, to regulate the amount of hydrogen produced by the hydrogen generating apparatus.

The cover may be coupled with the electrolyte bath 312 such that the wires 322 emerge outside the electrolyte bath 312. To let portions of the wires 322 emerge out of the electrolyte bath 312, through-holes may be formed in the cover through which the wires 322 may pass. Here, in order to prevent the hydrogen generated in the electrolyte bath 312 from leaking out, a sealant may be applied in the through-holes. Thus, the inside and outside of the electrolyte bath can be isolated.

FIG. 6 is a flowchart illustrating the regulating of hydrogen flow rate according to an embodiment of the invention. A process for regulating the flow rate of hydrogen will be described below with reference to FIG. 6. First, a switch may be turned on, or a variable resistance may be set low, in a hydrogen generating apparatus, such that hydrogen is generated to a particular pressure, and setting values for hydrogen may be configured (S10). Here, the setting values may include an upper limit (B₁), a lower limit (B₂), and a maximum setting value (C).

Next, the pressure (A) inside the fuel channel 306 may be measured using a pressure sensor 308 (S20). The setting values may be compared with the measured pressure value (A) (S30).

For this, the setting values may be inputted as an upper limit (B₁) and a lower limit (B₂) (S40), which may be compared with the measured pressure (A) (S42).

When the degree of power consumption is high in the electronic device and the amount of hydrogen expended in the fuel electrode 300 is increased, the pressure of hydrogen held inside the fuel channel 306 of the fuel electrode 300 may be lowered. If the measured pressure (A) inside the fuel channel 306 measured using the pressure sensor 308 is lower than the lower limit (B₂) setting, the switch may be turned on or the variable resistance may be lowered in the hydrogen generating apparatus, to allow a greater electric current to flow between the electrodes (S440). In this way, more hydrogen can be supplied to the fuel electrode 300, by which the pressure may be increased according to the amount of hydrogen in the fuel channel 306. Conversely, if the degree of power consumption is decreased in the electronic device, the pressure inside the fuel channel 306 may be increased, due to the continuous generation of hydrogen. If the measured pressure (A) inside the fuel channel 306 is higher than the upper limit (B₁) setting, the switch may be turned off or the variable resistance may be increased in the hydrogen generating apparatus, to reduce the amount of hydrogen generation (S442). In this way, the internal pressure in the fuel channel 306 of the fuel electrode 300 can be lowered.

If the measured pressure (A) is maintained between the upper limit (B₁) and the lower limit (B₂), the switch may be turned on and off alternately, or a low resistance and high resistance may be alternated, in the hydrogen generating apparatus (S444).

Therefore, without the need for complicated procedures, such as of measuring the power required in the electronic device and comparing with the power of the fuel cell, it is possible to implement on-demand control as required by the electronic device, by maintaining a constant pressure inside the fuel channel 306 of the fuel electrode 300.

Alternately, a maximum setting (C) may be inputted (S50), when inputting the setting values, to compare the measured pressure (A) with the maximum setting (C) (S52).

If the measured pressure (A) is lower than the maximum setting (C), the pressure of the hydrogen generating apparatus may be considered to be at an appropriate level, and thus the valve 310 may not be operated (S540).

Conversely, if the measured pressure (A) is greater than the maximum setting (C), there is a risk of problems occurring in the fuel electrode 300, which may lead to a problem in regulating the flow rate of hydrogen. If the hydrogen generating apparatus creates a pressure exceeding a certain level, such as to an extent that there is a danger of the hydrogen generating apparatus exploding, the valve 310 may be opened (S542) and the hydrogen purged, to avoid such danger. In this manner, the hydrogen generating apparatus can be kept safe.

As set forth above, the fuel cell power generation system according to certain embodiments of the invention makes it possible to regulate the flow rate of hydrogen by a simple method of regulating pressure, and to increase reaction speed, without the use of a complicated feedback system which measures the power value of the electronic device and the power value of the fuel cell. Also, if abnormalities occur to excessively increase pressure, the hydrogen can be purged, keeping the hydrogen generating apparatus stable.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A fuel cell power generation system comprising:
a hydrogen generating apparatus configured to generate hydrogen;
a fuel electrode having a portion thereof coupled to the hydrogen generating apparatus and having a fuel channel formed therein and configured to receive the hydrogen and dissociate the hydrogen into hydrogen ions and electrons, the fuel channel having one side thereof open;
a membrane stacked on the fuel electrode such that the membrane covers the open side of the fuel channel;
an air electrode coupled to the membrane and configured to receive the hydrogen ions from the fuel electrode through the membrane; and
a pressure sensor formed on the portion of the fuel electrode and configured to measure a pressure inside the fuel channel and regulate a quantity of hydrogen supplied to the fuel electrode.

2. The fuel cell power generation system of claim 1, wherein the hydrogen generating apparatus comprises:
an electrolyte bath containing an electrolyte solution including hydrogen ions;
a first electrode positioned inside the electrolyte bath and dipped in the electrolyte solution and configured to generate electrons;
a second electrode positioned inside the electrolyte bath and dipped in the electrolyte solution and configured to receive the electrons and generate hydrogen; and
a control unit positioned between the first electrode and the second electrode and configured to control an amount of electrons flowing from the first electrode to the second electrode in correspondence to a pressure required at the fuel electrode.

3. The fuel cell power generation system of claim 2, wherein the control unit controls the amount of electrons according to a pressure value inputted by a user.

4. The fuel cell power generation system of claim 1, wherein the fuel channel has a dead end structure, having an end portion of the channel isolated from the exterior.

5. The fuel cell power generation system of claim 1, further comprising:
a valve interposed between the fuel electrode and the hydrogen generating apparatus and configured to regulate an internal pressure of the hydrogen generating apparatus.

6. The fuel cell power generation system of claim 1, wherein an air channel corresponding to the fuel channel is formed in the air electrode.
